(19) United States
(12) Patent Application Publication
(10) Pub. No.: US 2011/0049865 A1
(43) Pub. Date: Mar. 3, 2011

(54) Security Document Comprising a Security Feature Having a Layer with Particles

(76) Inventor: David Bray, Berkshire (GB)

(21) Appl. No.: 12/865,353

(22) PCT Filed: Feb. 20, 2009
(86) PCT No.: PCT/GB09/00491

§ 371 Date: Nov. 12, 2010

(30) Foreign Application Priority Data
Feb. 29, 2008 (GB) 0803866.3

(51) Int. Cl. B42D 15/00

(52) U.S. Cl. 283/114

(57) ABSTRACT

A security document comprising a printed security feature having a tactile feel, said security feature comprising a printed layer with particles protruding at least 10 μm therefrom in an amount of at least 3 particles per mm² of said layer.

The invention relates to printed security features for banknotes and other security documents.

It is common when providing security documents such as a series of banknotes having different denominations to make each document or banknote in the series generally similar to other banknotes in the same series. This may be for a variety of reasons including a desire to distinguish documents or banknotes of one series from others of another series. For example, the banknotes of one country will be designed to be generally similar but to be readily distinguishable from banknotes of another country.

Within a series, however, it is also necessary to distinguish between documents or banknotes having different features, values or denominations and conventionally this is achieved by providing one or more identifiers in the form of numeric and/or alphanumeric information which defines the feature or denomination concerned. In order to increase the ease of identifying a banknote of value, the identifier is often placed more than once on the banknote.

There has long been interest in making the various documents or banknotes within a series recognisable from each other by the visually impaired. Visually impaired can range from the totally blind to people with corrected visual acuity of no better than 20/70 in the better eye or who have a maximum visual field of no more than 30 degrees. Existing techniques used are: variable size currency, variable colour currency, large numerals, various arrangements of tactile markings, and special pattern shapes for different denominations.

Although these techniques are generally successful, there is a need for an improved technique.

It is known in the prior art to employ tactile printed markings generated by intaglio printing. These can enhance the blind recognition properties of documents such as banknotes. The intaglio printing process has existed for centuries and its unique characteristics are created by virtue of the physical difference between the non-image area, which is the surface of the plate and the image area, which are the recesses cut or etched into the plate.

The key steps of the intaglio printing process are:
1. Loading ink into the recessed areas of a printing plate.
2. Wiping the plate surface clean
3. Removing ink from those recesses in the plate onto the paper by pressure exerted onto the surfaces of those two elements.

In a conventional intaglio ink the pigment particle size distribution is narrow with a typical maximum particle size of 5 μm. A narrow particle size distribution is deliberately selected to enable the generation of high-resolution fine line structures from the intaglio printing process. The tactility generated by the intaglio printing process is a result of the depth of the engraving of the intaglio plate and the manner in which the depth and shape of the engravings vary across a particular image. Intaglio printing therefore provides a change in surface profile, detectable by touch, from the normal plane of the substrate but once the authenticator has detected this initial change there is no further change in tactility detected by simply moving a finger across the raised area due to the smooth surface of the intaglio ink. That is to say the ink film surface does not have any inherent human detectable tactile properties. In order to get a distinct tactile feel from an intaglio printed pattern the whole design must be typically raised at least 30 μm above the surface of the substrate and preferably greater than 50 μm above the surface of the substrate.

A challenge with using intaglio printing for blind recognition purposes is to generate significant additional or different tactility to the conventional intaglio print already on the document. Furthermore, conventional intaglio inks do not have the very high wear and abrasion resistance required for blind recognition features that will be regularly handled and rubbed in circulation. Additionally, different tactility cannot be recognised along the line of printing. It can only be determined across the line of printing

The present invention seeks to provide a solution to some or all of the above problems.

The present invention provides a security document comprising a printed security feature having a tactile feel, said security feature comprising a printed layer with particles protruding at least 10 μm therefrom in an amount of at least 3 particles per mm² of said layer.

In the present invention, the printed security feature is formed from a layer of, for example, a resin comprising particles which protrude from the surface of the layer providing a surface with a variable roughness detectable by human touch.

The particles may have an inherent body colour or be colourless or even transparent. They have a larger particle size and/or wider particle size distribution than in a conventional intaglio ink such that the tactility of the security feature of the current invention is significantly different from the tactility of a raised image produced from conventional intaglio ink.

The security feature of the current invention is typically printed onto the document, preferably using an intaglio or a screen printing process, though it should be recognised that due to the inherent tactile nature of the ink non-relief printing processes such as for example lithography, UV cured lithography, letterpress, flexographic printing, and gravure printing can also be used. An advantage of the current invention is that, unlike in the intaglio process, there is not a requirement to have a thick ink layer raised significantly above the surface of the substrate.

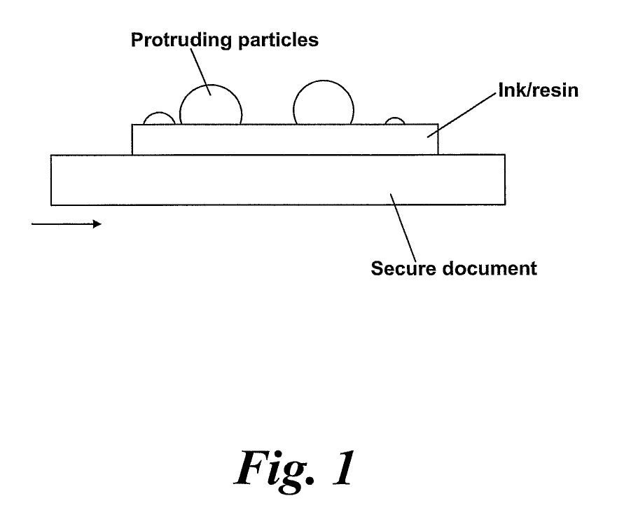

Although not essential it is preferable that the printing technique can apply a sufficiently thick layer of material such that the height of the ink or resin layer, not taking account of the protruding particles, relative to the document substrate can be detected by touch. In this manner the security feature of the current invention provides a number of tactile characteristics, illustrated schematically in FIG. 1, experienced by an authenticator as they move their finger across the feature. On moving in the direction shown by the arrow an authenticator firstly experiences the change in height on moving from the base substrate of the secure document to the height of the resin layer, on continuing to move across the feature the authenticator experiences a rough abrasive texture of variable height generated by the protruding particles. The tactile characteristics of the ink can be made similar to the tactile characteristics of a rough surface or sandpaper. The authenticator then returns to the smooth substrate of the resin layer before experiencing the change in height on going from the resin layer to the base substrate. The contrast between the rough abrasive texture generated by the protruding particles and the smooth texture of both the base substrate and the resin layer provides a feel which is distinctly different from conventional intaglio print and enables a blind or visually impaired person to quickly and confidently identify the security feature.

In a preferred embodiment of the current invention the security feature is applied to a secure document using screen printing. The technique of screen printing is widely recognized, and the technique includes applying printing ink to a thin silk screen which has pervious image areas, the ink being forced through said screen, generally by a squeegee assembly. The amount of ink transferred and hence the thickness of the printed layer can be controlled by varying the screen size and the viscosity of the ink. Various types of silk screens can be used for the current invention including flat screens and cylindrical screens mounted on a drum.

Particles for incorporation into the ink or resin are preferably particles with a high abrasion resistance and hardness. Preferably the particles have a hardness of greater than 5 on the Mohs hardness scale and even more preferably greater than 7. The Mohs scale of mineral hardness characterizes the scratch resistance of various minerals through the ability of a harder material to scratch a softer material. It was created in 1812 by the German mineralogist Friedrich Mohs and is a standard definition of hardness used in materials science.

It has been found that in order for the particles to be felt by a finger, there should be at least 3 protruding particles per mm² of the printed layer (i.e. the number of particles protruding by at least the stipulated distance), preferably at least 5, more preferably at least 10 or 15, even more preferably at least 25 and most preferably at least 50. Generally the number of such protruding particles is fewer than 500 per mm², more generally fewer than 200.

The stipulated number of particles preferably protrude by at least 10 μm, more preferably at least 20 μm, even more preferably by at least 30 μm, and even more preferably at least 40 μm, and most preferably by at least 50 μm. Generally the particles protrude less than 500 μm, more generally less than 100 μm.

The height the particles protrude above the surface of the ink and the number of particles protruding above the surface by a specified height per mm² can be measured using a surface profilometer such as the Talysurf Series 2 Instrument supplied by Taylor Hobson. This equipment can be used to produce multiple 2-D scans separated by a very small distance, and these are joined to produce a 3-D surface scan over a defined area. The resulting 3-D scans can be presented as flat false-colour images where the colour indicates the relative heights of the surface, and 2-D surface profiles can be extracted from the 3-D scans. The number of particles protruding from the surface in the defined area can be counted manually or by carrying out a “Volume of Islands” analysis on the defined area. In this analysis a threshold is set, which in this case is the specified height above the ink resin layer (for example 20 μm) and then the software will calculate the number of “Islands”, i.e. particles, above this threshold. The software can also calculate the volume of each “Island” hence the name “Volume of Islands” for the analysis.

In a preferred embodiment, at least 5, 10 or 15 particles per mm² of the layer protrude by at least 20 μm, and more preferably at least 10 per mm² protrude by at least 50 μm.

The D₅₀ average particle size of all the particles in the layer, including those which protrude and those which do not protrude, is preferably greater than 5 μm, more preferably greater than 10 μm and even more preferably greater than 15 μm.

The D₉₀ average particle size of all the particles in the layer, including those which protrude and those which do not protrude, is preferably greater than 20 μm, and even more preferably greater than 50 μm.

The particle size distribution may be broad. Thus generally at least 75% of the particles by number have a size of from 2 μm to 200 μm, preferably from 5 μm to 100 μm. The standard deviation of the particle size is, for example, at least 40 Am and preferably less than 100 μm. In another embodiment the particles may all generally be the same size, having a standard deviation of less than 5 μm.

Particle size and distribution are measured by standard light scattering techniques, for example using a Mastersizer 2000 instrument supplied by Malvern Instruments.

The particles are preferably present in the ink in an amount of from, for example, 5 to 50 wt % based on the total weight of the ink, preferably 10 to 30 wt %.

When applied to the substrate the thickness of the resin layer is preferably greater than 5 μm and even more preferably greater than 10 μm. The D₅₀ average particle size is preferably at least 50% of the thickness of the resin layer and more preferably at least 80% and even more preferably at least 100%.

Examples of particles suitable for the current invention include alumina, silica, zirconia, silicon carbide, silicon nitride, boron carbide, zeolite, alundum or a polymer such as polyacrylate. Preferably the particles are not treated. Thus they do not contain a separate surface layer, and/or are not treated to be electrically conductive. Preferably the ink or resin will comprise a wide distribution of particle sizes thereby providing a variable roughness across the security feature. Particles of any morphology can be employed in the current invention; however spherical particles or particles with low aspect ratios are preferred, to ensure a high proportion of the particles protrude from the surface of the ink without the need for controlling the particle alignment in the ink.

It has also been observed that some polymeric particles/beads can also achieve a unique tactile effect, for example a sandpaper type feel. Although the polymeric particles do not have as high an abrasion resistance and hardness as the inorganic particles the fact that they protrude from the surface of the ink still generates a similar tactile effect. Particularly suitable polymeric beads are polyacrlyate microspheres, one example of which is supplied under the tradename DECOSILK® ART by MicroChem.

Preferably, the particles are such that no dimension is greater than 150% of the smallest dimension (which is taken to be 100%), and more preferably no dimension is greater than 125% of the smallest dimension. Most preferably the particles are spherical.

The ink may be, for example, a lithographic, UV cured lithographic, letterpress, flexographic, gravure, intaglio or screen printing ink. An intaglio or screen printing ink is preferred, especially a screen printing ink. Such inks are well known to those skilled in the art and are explained in detail in for example, “The Printing Ink Manual”, Kluwer Academic publishers, Rev ed, September 1993, Robert Leach and R. J. Pierce.

Screen inks may generally comprise a polyvinyl alcohol or a UV curing acrylate. Intaglio inks may generally comprise a resin such as an alkyd modified resin ether or a combination of a polyester resin, polyester wax and a hydrocarbon solvent. Lithographic inks may generally comprise an alkyd based resin, for example Litho Varnish LV54001 supplied by Lawter.

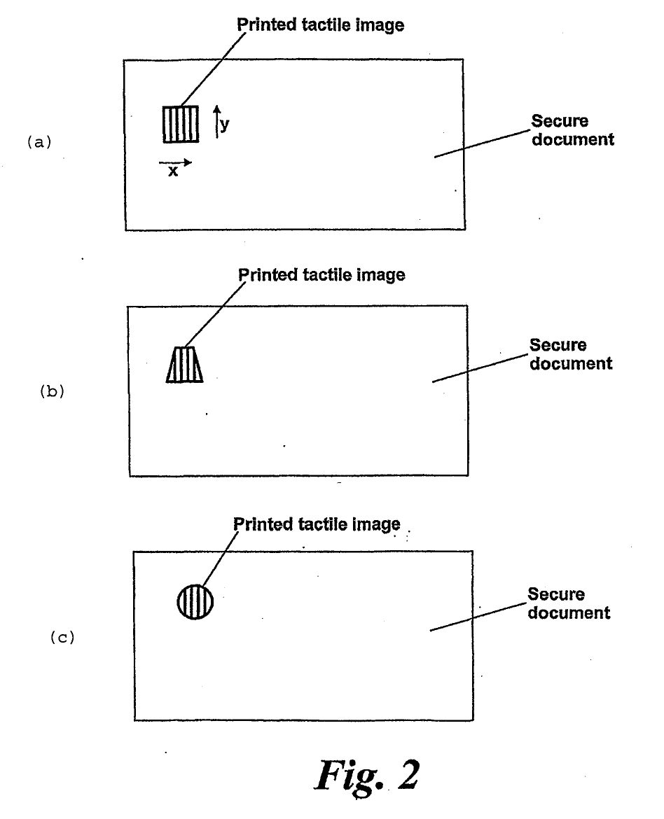

FIG. 2a-2c illustrates example designs for the security feature of the current invention. In this case the tactile feature is printed onto the document in the form of simple geometric shapes easily recognised by blind or visually impaired people. In each case the design comprises an outline of a geometric shape which is filled with vertical lines. If the authenticator moves their finger across the sample in the direction of arrow x they will feel a series of raised lines each with a perceptibly different rough abrasive texture due to the variation in height of the particles protruding from the surface of the ink. If the authenticator moves their finger across the sample in the direction of arrow y they will detect a continuous raised area which has a perceptibly variable roughness as they moves across the sample.

The tactile characteristics of the design in FIGS. 2a-2c can be contrasted with the tactile characteristics of the same design printed using intaglio printing with a conventional intaglio ink with for example each printed line being raised above the document substrate by 50 μm. In this case if the authenticator moves their finger across the sample in the direction of arrow x they will feel a series of raised lines each with the same texture. If the authenticator moves their finger across the sample in the direction of arrow y they will detect a continuous raised area with a smooth texture. The presence of the lines is therefore only detected by the authenticator due to the difference in height between the printed line and the document substrate. If the substrate is a banknote and undergoes continuous wear in circulation the height of the intaglio ink will be reduced and the tactile characteristics will become increasingly difficult to detect. This is a serious issue if the tactile characteristics are there as an identifier of the banknote denomination for a blind person. In contrast the printed security feature of the current invention does not rely solely on the height of the resin above the surface of the substrate as the particles provide an inherent surface roughness which will remain detectable even if the ink height is reduced in circulation.

For an intaglio printed image printed with a conventional intaglio ink any small scale variation in tactility can only be achieved by correctly spacing the edges of multiple intaglio printed areas, for example the lines in FIG. 2a. This is not required for the security feature achieved by the printing ink of the current invention where the local variation in roughness is an inherent property of the ink and therefore small scale variations in roughness are felt across solid unbroken uniform designs.

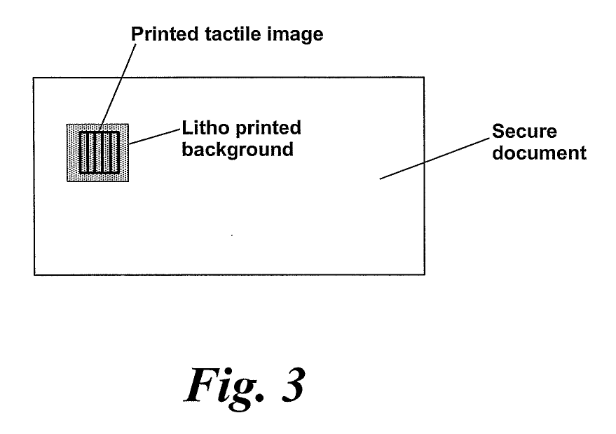

The designs may be colourless or coloured. In a preferred embodiment, suitable for the visually impaired, the particles are incorporated into a black ink or resin and the tactile feature is printed onto a contrasting colour, for example bright yellow. An example of this is illustrated in FIG. 3 where a black tactile image of a square is screen printed on top of a yellow lithographically printed background.

Suitable designs for the security feature of the current invention are preferably in the form of simple images such as patterns, symbols and alphanumeric characters and combinations thereof. The indicia can be defined by patterns comprising solid or discontinuous regions which may include for example line patterns, dot structures and geometric patterns. Possible characters include those from non-Roman scripts of which examples include but are not limited to, Chinese, Japanese, Sanskrit and Arabic.

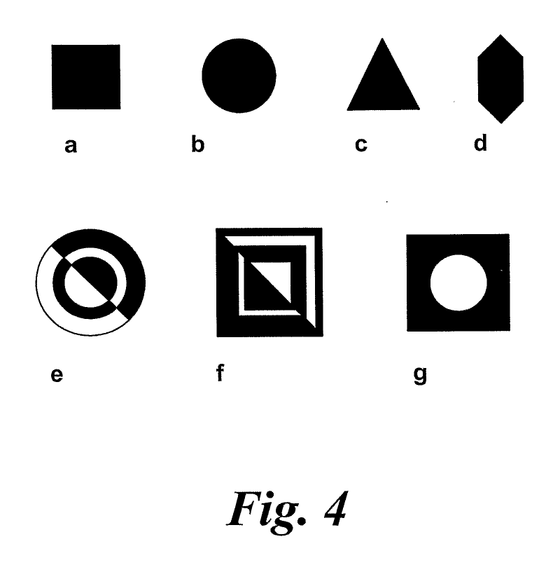

FIG. 4 illustrates a variety of example designs for the printed layer used in the present invention. Preferably the line widths for the design are greater than 1 mm in order that the variation in surface roughness can be felt along both the width and length of the lines.

FIGS. 4a-4d show examples of simple geometric shapes filled as a solid colour with an ink containing particles. The variable roughness across the solid area provides the device with a unique feel, different to that of conventional tactile security printing, enabling the shape to be easily identified by a partially sighted or blind person.

FIGS. 4e-4f illustrate designs with multiple printed and non-printed regions. The printed regions are printed with the tactile ink used in the present invention. The printed regions have a surface area of preferably at least 2 mm² and more preferably greater than 4 mm². The contrast of the relative smooth texture of the base substrate with the rough abrasive sandpaper type effect of the printed region aids the partially sighted or blind person in correctly identifying the location and pattern of the security feature. Preferably each printed region is fully enclosed by a non-printed region and vice-versa

The security feature of the current invention could be provided with both human and machine-readable feature. For example the base ink, resin or pigment can comprise a phosphorescent, luminescent, magnetic, or infrared readable property. In addition the base ink, resin or pigment may exhibit one or more further security characteristics and/or comprise additional materials, for example optically variable materials, multi-layer thin-film interference materials, liquid-crystal materials, holographic materials, thermochromic materials, and/or photochromic materials

The security feature of the current invention can be used to authenticate a variety of substrates but is particularly suitable for application to flexible substrates such as paper and polymer films and in particular a document of value such as a banknote, travellers cheque, certificate of authenticity, stamp, bond, tax disc, fiscal stamp, secure label, passport or voucher.

The security feature of the current invention can be applied to a substrate, for example a polymer or paper substrate, which is then applied to or incorporated into a security document such that the security feature is exposed on a surface of the security document.

The substrate such as a polymer or paper substrate may be applied to or incorporated into the security document by any conventional method known in the prior art, for example as a patch, foil, stripe, strip or thread. The substrate may be arranged either wholly on the surface of the document, as in the case of a stripe or patch, or may be in localised regions on the surface of the document in the form of a windowed security thread. Security threads are now present in many of the world's currencies as well as vouchers, passports, travellers' cheques, identity cards, authentication labels, postal stamps and other security documents. In many cases the thread is provided in a partially embedded or windowed fashion where the thread appears to weave in and out of the paper. Methods for producing paper with so-called windowed threads are described in EP-A-0,059,056 and EP-A-0,860,298.

Other methods for incorporating a substrate such as a polymer or paper substrate such that it is exposed on both sides of the security document are described in EP-A-1,141,480, WO-A-03/054,297 and WO-A-2007/071,937.

The present invention is now further illustrated by the following Examples.

### EXAMPLES

### Example 1

An ink was prepared by mixing G-800 Zeeospheres with a commercial screen ink as set out in the following table. Zeeospheres G-800 are ceramic microspheres, supplied by 3M Speciality Materials, having a hardness value of 7 on the Mohs scale.

The G-800 Zeeospheres have a particularly wide particle size distribution, detailed in the table below, which is preferable for the current invention.

| | Particle size (microns) |
|---|---|
| 95^{th} percentile | 200 |
| 90^{th} percentile | 75 |
| 50^{th} percentile | 18 |
| 10^{th} percentile | 2 |

The screen ink was resin 0033-4172 supplied by National Starch and Chemical Company

Screen Ink Formulation 1

| Component | WT % in wet ink |
|---|---|
| Resin - 033-4172 | 77 |
| Zeeosphere G-800 | 23 |

### Example 2

An ink was prepared based on screen ink 80-049, which is a UV curable resin from Nor-Cote International.

Screen Ink Formulation 2

| Component | WT % in wet ink |
|---|---|
| Resin - 80-049 | 70 |
| Zeeosphere G-800 | 30 |

### Example 3

A screen ink was prepared using Decosilk 90 particles. These are polyacrylate microspheres supplied under the tradename DECOSILK ART by MicroChem having a D₅₀ of 90 μm.

Screen Ink Formulation 3

| Component | WT % in wet ink |
|---|---|
| Resin - 80-049 | 70 |
| Decosilk 90 | 30 |

### Example 4

A lithographic ink was prepared based on lithographic printing ink vehicle 9H0011S from Sicpa.

Lithographic Ink

| Component | WT % in wet ink |
|---|---|
| Lithographic printing ink vehicle | 76.5 |
| Zeeosphere G-800 | 21.9 |
| Antioxidant | 1 |
| Cobalt Driers | 0.6 |

### Example 5

An intaglio ink was prepared based on intaglio printing ink vehicle W2006440 from Intercolour

Intaglio Ink

| Component | WT % in wet ink |
|---|---|
| Intaglio printing ink vehicle | 46 |
| Zeeosphere G-800 | 18 |
| Transparent filler - e.g. aluminum silicate | 34 |
| Antioxidant | 1 |
| Cobalt Driers | 1 |

### Example 6

The screen ink of Example 2 was printed on a substrate in different layer thicknesses. The number of particles protruding was measured.

| | | | Number of Particles/mm² | | | |
|---|---|---|---|---|---|---|
| | | | protruding above the resin/ink | | | |
| | | Resin | layer by a height of greater | | | |
| | D₅₀ | Thickness | than x μm | | | |
| Tactile Feel | (μm) | (μm) | X = 10 | X = 20 | X = 30 | X = 40 |
| Rough - feature | 18 | 20 | 77 | 18 | 5 | 2 |
| easily | | | | | | |
| identifiable | | | | | | |
| Semi-rough - | 18 | 35 | 15 | 6 | 3 | 0.2 |
| feature still | | | | | | |
| identifiable | | | | | | |
| Smooth | 18 | 60 | 2 | 0.2 | 0.2 | 0.2 |

### Example 7

The screen ink of Example 3 was printed on a substrate in a layer thickness of 40 μm. The number of particles protruding was measured.

| | | | Number of Particles/mm² protruding | | | |
|---|---|---|---|---|---|---|
| | | Resin | above the resin/ink layer by a | | | |
| | D₅₀ | Thickness | height of greater than x μm | | | |
| Tactile Feel | (μm) | (μm) | X = 10 | X = 20 | X = 30 | X = 40 |
| Rough - feature | 90 | 40 | 10 | 10 | 10 | 10 |
| easily | | | | | | |
| identifiable | | | | | | |

1. A security document, said document comprising: a printed security feature having a tactile feel, said security feature including a printed layer with particles protruding at least 10 μm therefrom in an amount of at least 3 particles per mm² of said layer.

2. The document according to claim 1 wherein the printed layer comprises at least 5 protruding particles per mm² of said layer.

3. The document according to claim 2 wherein the printed layer comprises at least 10 protruding particles per mm² of said layer.

4. The document according to claim 1 wherein said particles protrude at least 20 μm.

5. The document according to claim 4 wherein said particles protrude at least 30 μm.

6. The document according to claim 1 wherein said particles protrude less than 100 μm.

7. The document according to claim 1 wherein the D₅₀ average particle size is greater than 5 μm.

8. The document according to claim 7 wherein the D₅₀ average particle size is greater than 10 μm.

9. The document according to claim 8 wherein the D₅₀ average particle size is greater than 15 μm.

10. The document according to claim 1 wherein the D₉₀ average particle size is greater than 20 μm.

11. The document according to claim 10 wherein the D₉₀ average particle size is greater than 50 μm.

12. The document according to claim 1 wherein the standard deviation of the particle size is 40 to 100 μm.

13. The document according to claim 1 wherein the particles have a hardness of greater than 5 on the Mohs hardness scale.

14. The document according to claim 13 wherein the Mohs hardness is greater than 7.

15. The document according to claim 1 wherein the particles are selected from the group consisting of: alumina, silica, zirconia, silicon carbide, silicon nitride, boron carbide, zeolite, alundum and polymer particles.

16. The document according to claim 1 wherein the particles are sized such that no diameter is greater than 150% of the smallest diameter.

17. The document according to claim 16 wherein the particles are spherical.

18. The document according to claim 1 wherein the printing process of the security feature is selected from the group consisting of: screen, lithographic and intaglio printing.

19. The document according to claim 1 wherein the security feature is printed onto a contrasting color.

20. The document according to claim 1 being selected from the group consisting of: a bank note, travellers check, certificate of authenticity, stamp, bond, tax disc, fiscal stamp, secure label, passport and voucher.
